(19) United States
(12) Patent Application Publication
(10) Pub. No.: US 2023/0075397 A1
(43) Pub. Date: Mar. 9, 2023

(54) PHYSICAL WATER TREATMENT DEVICE

(71) Applicant: Swiss Aqua Technologies AG, Cham (CH)

(72) Inventor: Frantisek PANCURÁK, Presov (SK)

(21) Appl. No.: 17/927,697

(22) PCT Filed: May 27, 2021
(86) PCT No.: PCT/EP2021/064157

§ 371 Date: Nov. 24, 2022

(30) Foreign Application Priority Data
May 28, 2020 (CZ) PV 2020-304

(51) Int. Cl. C02F 1/461; C02F 1/46; C02F 1/467; C02F 1/48; C02F 5/00

(52) U.S. Cl. CPC C02F 1/46176; C02F 1/4602; C02F 1/4676; C02F 1/481; C02F 5/00; C02F 2301/024; C02F 2301/026; C02F 2303/22; C02F 2201/007; C02F 2001/46152

(57) ABSTRACT

The physical water treatment device, in particular in a flexible water inlet (1), comprises at least one pair of electrodes (2) for water galvanization and at least one means for inserting and fixing the electrodes (2). The means for inserting and fixing the electrodes (2) together with the electrodes (2) form an integral body (3), the resulting shape of which is adapted for the insertion into the flexible water inlet (1). The integral body (3) completely blocks the flexible water inlet (1) and is hollow so that the water flowing through the flexible inlet (1) flows through the electrodes (2) of the integral body (3). The electrodes (2) form a flow-through galvanization system in the integral body (3).

### FIELD OF THE INVENTION

The invention relates to a physical water treatment device, in particular water treatment for protection against limescale.

### BACKGROUND OF THE INVENTION

Limescale is a deposit that builds up on the walls of pipes, bathrooms, and in water appliances, and is formed by deposition of minerals present in medium-hard and hard water. The basic component of limescale is usually calcium carbonate (CaCO₃).

One of the known solutions for protection against limescale deposits is physical water treatment on the electro-galvanic principle. Two electrodes of different materials according to the Beketov's series of metals are immersed in flowing water to be treated to create a difference in electrical potentials between the electrodes. The difference in electrical potentials results in the release of metal nanoparticles from the anode electrode, which perform the function of crystallization nuclei, on which the minerals present in water agglomerate into larger formations, which subsequently have a much lower tendency to deposit in the form of limescale.

The use of the electro-galvanic principle for physical water treatment is known from document SK 1272019 (U1), in which an ionic polarization unit for water treatment is presented. The polarization unit consists of a solid hollow body, which replaces part of the water supply pipe. Systems of electrodes for the electro-galvanic principle of water treatment are inside the body. At the same time, the electrodes are shaped to cause non-destructive cavitation phenomena in the flowing water, which help in the process of water galvanization by stirring up the water flow streamlines.

Another known solution for physical water treatment is the technical solution from document SK 1252019 (U1), which describes an ionic polarization device for physical water treatment. The polarization device is made as a cartridge formed by a system of electrodes, which is inserted into a solid two-chamber vessel. The two-chamber vessel is installed to the water pipeline. Water flows gradually through both chambers of the vessel, while water in the cartridge is galvanized. The electrodes differ in shape for each of the chambers, with the turbulent coupling retarder arranged at the interface between the chambers. The function of the turbulent coupling retarder is to ripple the flowing water to stir up the water flow streamlines.

The above-mentioned known solutions have the common disadvantage, i.e. they need to be installed on a pipe. This means that both known solutions have the requirement for sufficient installation space, as they are not flexible in shape. As a rule, the above-mentioned known devices are installed to the water supply pipes in places where there is enough installation space to leave them, for example at the main water shut-off valve, or on pipes in technical rooms. However, in many cases, water consumers do not have access to water supply pipeline, or do not have sufficient installation space to install the above-mentioned devices.

A partial solution to the problems of the above-mentioned background of the invention may be the invention known from document WO 2019043004 (A1), in which water treatment by means of a system of disc-shaped electrodes arranged in a row is presented. The description of the invention shows that the system of electrodes allows limited flexibility of the pipeline within which the system of electrodes is located, whereby the problem of the requirement for sufficient installation space can be solved. However, the disadvantages of the present invention are that the limited flexibility it provides is not suitable for installation in front of single household water appliances, which is generally the only place for water consumers where they can physically treat water in home environment. The inlets of water appliances are usually made up of flexible hoses, e.g. inlet hoses for washing machines, coffee machines, shower heads, etc., and which need to maintain the flexibility of water inlet pipes/hoses as much as possible.

A person skilled in the art could, at first glance, find technical information in the invention from document WO 03008342 (A1) to solve the problem of maintaining the flexibility of water inlet. The present invention serves the purpose of water treatment to remove pathogens present therein with the aid of silver or other metals with an oligodynamic effect. The invention presents that a fibre with metal with an oligodynamic effect is conducted along the inner wall of the flexible water inlet, which acts on pathogens when the water flows through the flexible inlet. In addition, a second fibre of another metal is conducted parallel to the oligodynamic fibre, with the fibres being held in parallel by plastic clamps. First, the fibres serve as a flexible member, and second, there is a difference in electrical potentials between the two parallel fibres.

On the other hand, in a detailed analysis of the invention from document WO 03008342 (A1), a person skilled in the art of physical water treatment will find shortcomings which reduce the effectiveness of the present invention. The most fundamental shortcoming is that the metal fibres are arranged to the inner wall of the flexible water inlet, so that the water of the streamlines in the middle of the water flow does not come into sufficient contact with the metal fibres at the walls of water inlet to ensure its proper treatment. In the flow treatment of water, it is essential that the flowing water be stirred up as much as possible for galvanization in the entire cross-section of the flow. The present invention does not achieve this.

The above-mentioned shortcoming consisting in insufficient disturbance of water streamlines inside the water inlet is solved by the invention from document TWM 548689 (U). The invention presents a water inlet, inside which there is a magnetic screw insert, which forces the flowing water to turbulence, thus allowing the magnetic field to act on water in the entire cross-section of the flow. The magnetic field reverses the clusters of water molecules to dissolve them into smaller units. The disadvantage of this solution is that the water inlet is not flexible, but has a permanent shape similar to “V” or “U”.

The background of the invention shows that no solution is known so far which would leave the water inlet flexible and which at the same time could physically treat the flowing water within the entire cross-section of the flow, not only at the walls of the water inlet.

The purpose of the invention is to provide a physical water treatment device which can, with maximum efficiency, treat water directly in a flexible water inlet without completely losing the flexibility of the water inlet.

### SUMMARY OF THE INVENTION

The set task is solved by means of a physical water treatment device according to the invention below.

The physical water treatment device, in particular in a flexible water inlet, comprises at least one pair of electrodes for water galvanization and at least one holder into which the electrodes are inserted and which fixes the electrodes.

The core of the invention is based on the fact that the means for inserting and fixing the electrodes together with the electrodes form an integral body which has the shape adapted for insertion into a flexible water inlet. The integral body completely encloses the cavity of the flexible water inlet, with the integral body being hollow for the flow of water through it. The electrodes in the integral body form a flow-through turbulent galvanization system of electrodes.

The main advantage of the invention is that it can block the flow of water inside the flexible inlet, so that all water must flow through the galvanization system of electrodes. In addition, it is advantageous to insert it into a flexible water inlet, which protects the device from damage or theft. In addition, the device limits the flexibility of relatively small section of the flexible inlet with respect to its overall length, so that the flexible inlet does not lose its advantages.

The integral body is preferably adapted for fixed or loose insertion into a flexible water inlet. The loose insertion allows the device inside the water inlet to be moved as required by installation, but the fixed insertion protects the device from accidental falling out of the water inlet. In addition, in the case of chaining of several integral bodies in a row within a single device, the fixed insertion prevents them from moving away at any spacing. On the other hand, longer chaining close to each other can lead to a partial reduction in the flexibility of water inlet. Otherwise, the chaining of several integral bodies with arbitrary spacings, the flexibility of water inlet is preferably reduced at a minimum.

In a preferred embodiment of the device according to the invention, the electrodes of the integral body are provided with openings for the flow of water through the electrodes, with at least some of the openings being provided with stirring-up vanes. This is advantageous because the water not only washes the electrodes, but is actively stirred up by forced flow through the electrode material. In addition, it is advantageous if the refining is supported by stirring-up vanes which stir up the flowing water even more.

In a preferred embodiment of the device according to the invention, the integral body is a capsule. The end bases of the capsule are straight, or pyramidally raised, or roundly convex, or a combination of the list of variants, with the end bases being provided with openings for the flow of water through the capsule. The capsule design has the advantage of greater mechanical protection of the electrodes within the device. For flexible water inlet pipes/hoses, the flexibility of walls is assumed, so that in the case of external force acting on the wall of flexible water inlet, the capsule shape distributes this force effect better than if the compressed wall of inlet acted directly on the electrodes. In addition, in the case of close chaining of integral bodies, pyramidal or round convex bases have the function of defining the safe distance of adjacency, so that bending of the flexible water inlet does not cause collision and damage between adjacent bodies, which would lead to loss of flexibility of water inlet.

In terms of water stirring-up quality, experimental testing proves corrugated sheet electrodes to be advantageous for the capsule, which are sandwiched on top of one another, as well as electrodes which form at least one pair in the capsule in which they interlock, and last but not least electrodes which form at least one row of three electrodes in the capsule for blocking the flow of water, arranged in a row bevelled and parallel next to each other, and at the same time the middle bevelled electrode is inclined in the opposite direction from the end bevelled electrodes and forms a pair for water galvanization with each of the end bevelled electrodes.

In another preferred embodiment of the device according to the invention, the means for inserting and fixing the electrodes is formed by a ring for creating a contact surface with the inner side of the flexible water inlet. At the same time, flexible electrode terminals protrude from the front and rear of the ring. The flexible electrode terminals protrude preferably symmetrically from the ring and are provided with grooves for the insertion of electrodes. The ring design places lower resistance to water flow, while maintaining high galvanization efficiency. At the same time, the flexible electrode terminals have little effect on the flexibility of water inlet.

It is preferred if, in the ring-shaped design, the electrodes have the shape composed of a cross for inserting its arms into the grooves of the flexible terminals and further composed of stirring-up vanes having a shape substantially similar to the shape of propeller blades. The cross forms a support that resists the force of the flowing water and the stirring-up vanes refine the water for effective galvanization.

In an alternative preferred embodiment of the device according to the invention, the means for inserting and fixing the electrodes is formed by an assembly of at least three concentric rings to form an interface with the inside of the flexible water inlet, in which adjacent rings are connected to each other by at least one flexible spacer, with the central rings being provided with at least one groove for inserting the electrodes. The end rings form protective stops, so they are without electrodes. Flexible spacers prevent the rings from being crushed together or from being spaced apart, and in addition allow the device to bend to a limited extent together with the flexible water inlet in the case of an attempt to bend the flexible water inlet. Also for this second embodiment of the device according to the invention, it is preferred if the electrodes have the shape composed of a cross for inserting its arms into the ring and further composed of stirring-up vanes having a shape substantially similar to the shape of propeller blades.

According to experimental testing, the electrodes are preferably made of sheet metal “U” profile, and in addition, in a more preferred variant, the two electrodes of the “U” profile form at least one pair in which they interlock.

Another preferred embodiment of the invention is one in which the means for inserting and fixing the electrodes is formed by at least one inner rod passing through the electrodes and at least two peripheral rods passing through the electrodes at their perimeter. The rods fix the electrodes in a concentric arrangement. At the same time, the ends of the rods are provided with locking means, the role of which is to prevent the electrodes from slipping out of the rods. Furthermore, the peripheral rods are provided with locking means at the intersections through the electrode at their perimeters so that the peripheral rods are not released from the electrodes. Spacer rollers are also loosely mounted on the rods between two adjacent electrodes, the task of which is to prevent the electrodes from approaching each other. The integral body of rods and electrodes is preferably embedded in an electrically non-conductive sleeve. The sleeve has two functions. The primary function is to prevent electrical contact with the wall of the flexible water inlet, in particular if it is a metallic material of which the flexible inlet is made. The secondary superstructure function of the sleeve is to increase the rigidity of the integral body, which is desirable in particular in installation in the existing flexible water inlet pipes/hoses.

In a preferred embodiment of the device according to the invention, the device is provided with a shielding of electromagnetic fields in each of the integral bodies, or a common shielding arranged on the flexible water inlet for at least two integral bodies arranged in a row, or the device is provided with a shielding for arrangement between the inner wall of the flexible water inlet and integral bodies. External electromagnetic fields can cause the accumulation of charge on the electrodes, which in turn limits the galvanization process of physical water treatment.

In a preferred embodiment of the device according to the invention, at least one flow-through turbulent galvanization system of electrodes is provided with at least one permanent magnet. The magnetic field from the permanent magnet will make it possible to reverse the polarity of the existing clusters of magnetic dipoles of molecules in the water, which could serve as a basis for the growth of limescale.

Advantages of the invention include maintaining the flexibility of water inlet. The invented device is suitable both for newly manufactured flexible water inlet pipes/hoses and for existing ones, in which an average skilled worker can install it. At the same time, a high water galvanization effect is achieved, as the entire volume of water flowing through the flexible inlet must flow through the device. It is not possible for some of the water flow streamlines to pass through the device and not wet the surface of the electrodes.

### EXPLANATION OF DRAWINGS

The present invention will be explained in detail by means of the following figures where:

FIG. 1 shows a side view of a capsule device, in particular one of its bases provided with holes for water flow,

FIG. 2 shows an axonometric view of one capsule device,

FIG. 3 shows a longitudinal section of a capsule device,

FIG. 4 shows an axonometric view of a capsule device with one half of the means for inserting and fixing the electrodes removed,

FIG. 5 shows an axonometric view of one electrode from the system of electrodes of the capsule device,

FIG. 6 shows the shielding of external electromagnetic fields in the form of a screen copying the shape of the integral body of the device,

FIG. 7 shows a section of a device consisting of seven capsules installed in a flexible water inlet,

FIG. 8 shows an axonometric view of the left half of the system of electrodes of the capsule for locking into the right half of the system of electrodes,

FIG. 9 shows an axonometric view of the right half of the system of electrodes of the capsule for locking into the left half of the system of electrodes,

FIG. 10 shows an axonometric view of the system of electrodes of the capsule of two interlocking electrodes,

FIG. 11 shows an axonometric view of a system of standing electrodes for a capsule,

FIG. 12 shows a system of standing electrodes for a capsule in a top view,

FIG. 13 shows a system of standing electrodes for a capsule in a front view,

FIG. 14 shows the left end standing electrode for a capsule in a front, side and axonometric view at the same time,

FIG. 15 shows the central standing electrode for a capsule in a front, side and axonometric view at the same time,

FIG. 16 shows the right end standing electrode for a capsule in a front, side and axonometric view at the same time,

FIG. 17 shows a device with an integral body formed by a ring with flexible electrode holders,

FIG. 18 shows the means for inserting and fixing the electrodes formed by a ring with electrode holders,

FIG. 19 shows a detail of an electrode for a device with an integral body formed by a ring with flexible electrode holders,

FIG. 20 shows a device with an integral body formed by rings with circular electrodes arranged in central rings,

FIG. 21 shows a device with an integral body formed by rings with linear “U” electrodes arranged in central rings,

FIG. 22 shows a detail of a linear “U” electrode for a device with an integral body formed by rings,

FIG. 23 shows an integral body formed by electrodes slid on rods,

FIG. 24 shows a cross-sectional detail of a device with an integral body formed by electrodes slid on rods inserted into a sleeve interwoven with shielding of electromagnetic fields.

### EXAMPLES OF THE EMBODIMENTS OF THE INVENTION

It shall be understood that the specific cases of the invention embodiments described and depicted below are provided for illustration only and do not limit the invention to the examples provided here. Those skilled in the art will find or, based on routine experiment, will be able to provide a greater or lesser number of equivalents to the specific embodiments of the invention which are described here.

To carry out the invention, the condition must be fulfilled that the shape of cross-section of the integral body 3 corresponds to the shape of cross-section of the cavity of flexible water inlet 1 typically a pipe or a hose. In the vast majority of cases, the cross-section of the cavity of flexible water inlet 1 is circular, but it is possible to adapt the invention to be implemented with a different shape of cross-section of the inlet 1. By fulfilling this condition, the integral body 3 touches the inner wall of the inlet 1. The contact between the inner wall of the inlet 1 and the body 3 causes the integral body 3 in the inlet 1 not to travel and at the same time prevents water from flowing around the body 3. To increase the friction in the contact area, it is possible to increase the dimension of the body 3 to be pressed against the inside of the inlet 1. Alternatively, it is sufficient to select the material of the body 3 such that it has a high coefficient of shear friction with respect to the material of the inner wall of the inlet 1. It is also possible to create a constriction on the inlet 1 before and after the first integral body 3 of the device, which would block the possibility of displacing the bodies 3 in the inlet 1.

In the exemplary embodiment of the capsule integral body 3, the bases of the body 3, which are transverse against the flow of water, are provided with openings 5 for the flow of water through the capsule and the system of electrodes 2 enclosed therein. In preferred embodiments of the invention, the bases are pyramidal or convex towards the centre of the body 3. Shaping the bases has two tasks. Firstly, it reduces the resistance of the body 3 to the flow of water and, secondly, when arranging several bodies 3 in a row in a single device, the shaping of bases makes it possible to maintain the flexibility of water inlet 1. Again, in the overwhelming embodiments of the invention, the shape of the bases of the capsule bodies 3 will be round convex, but the invention can also be used with other shapes of the bases of capsules, provided that the condition of flexibility of the water inlet 1 is maintained. A person skilled in the art can handle this task for specific water inlet pipes/hoses 1 as part of his/her routine work.

In the simplest embodiment of the device, the capsule integral body 3 has a spherical shape. The spherical shape meets the requirement to maintain the flexibility of the inlet 1 if the spherical capsules are arranged in a row, since the spherical surfaces do not collide at the point of bending of the water inlet 1. A disadvantage of the spherical embodiment of the invention is that the spherical body 3 provides a small storage space for the electrodes 2 for water galvanization.

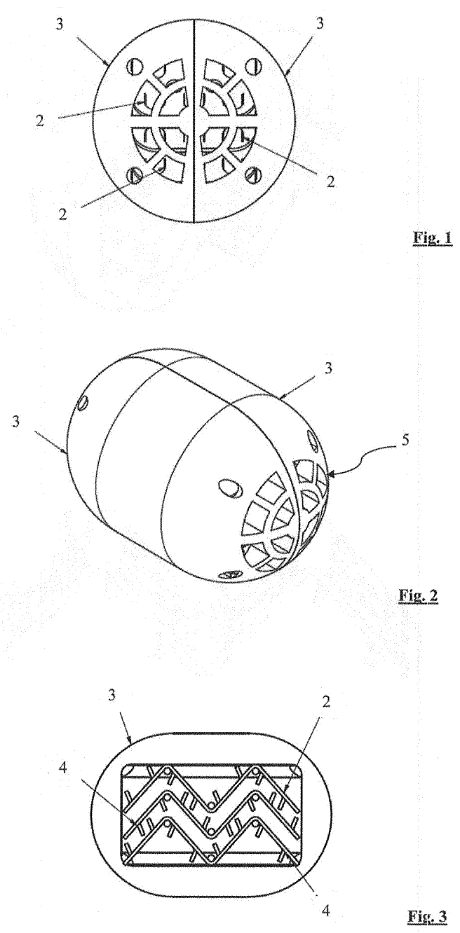

In a preferred embodiment of the invention, the capsule integral body 2 is cylindrical with round convex bases. A preferred embodiment of the invention is shown in FIGS. 1 to 4. As shown in the figures, the integral body 3 provides sufficient space for the system of electrodes 2. The fixing part of the integral body 3 can be made of plastic. The openings 5 are designed so that the device causes the least possible resistance to the flow of water.

In this particular embodiment of the invention shown in FIG. 3 and FIG. 4, the system of electrodes 2 is formed of corrugated sheet electrodes 2. The electrodes 2 must be different in material and must alternate to create a difference in potential as soon as they are wetted by water. The materials for electrodes 2 are selected according to the doctrine of the Beketov's series of metals and according to the requirements for the quality of galvanically treated water, in particular in terms of health safety. The selection of specific materials for the electrodes 2 is not a task for the person skilled in the art beyond professional skills.

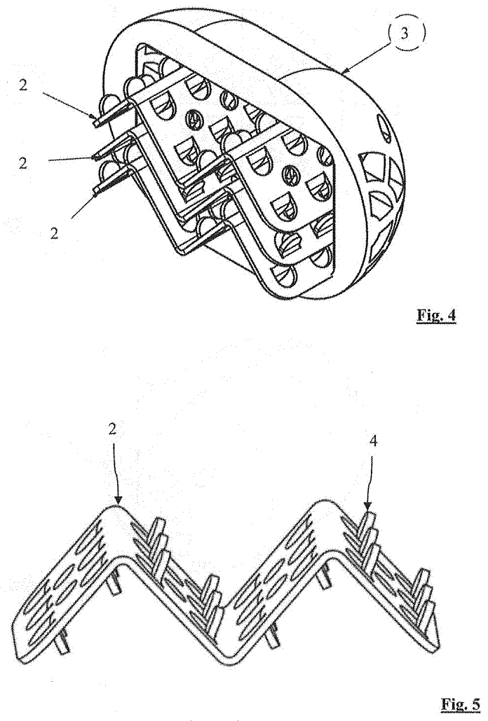

As shown in FIG. 5, the electrode 2 is made of corrugated sheet metal and is provided with simple openings and further with stirring-up vanes 4. The stirring-up vanes 4 of the intersections alternate with each other, both on the electrode 2 and the alternation is also respected between successive electrodes 2 in the integral body 3.

FIG. 6 shows a screen cage of the shielding 13 of the electromagnetic field. The shielding 13 shown is inserted into the integral body 3. In other non-illustrated embodiments of the invention, the shielding may be formed by coating of the flexible water inlet 1, or may be, for example, in the form of stocking slid over several successive integral bodies 3, or may lie between the inner wall of the flexible inlet 1 and the outer wall of the bodies 3.

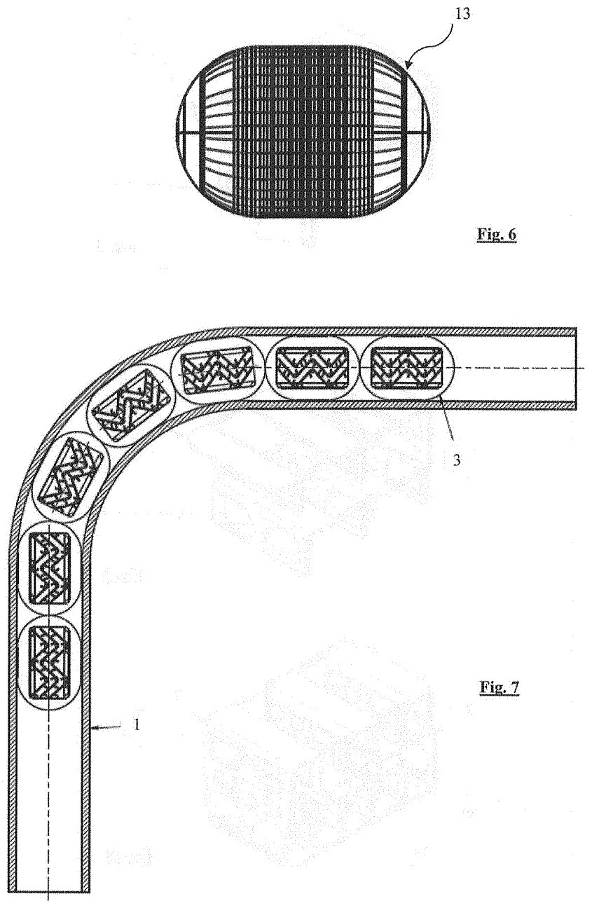

FIG. 7 shows a cross-section of a device of seven integral capsule-shaped bodies 3 installed in a flexible water inlet 1, which is bent and have a 90° change of direction on the flexible water inlet 1 to show that the bodies 3 do not interfere with each other.

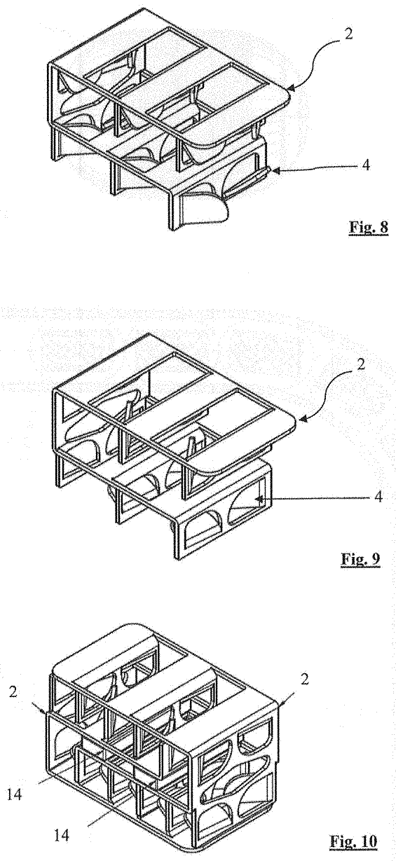

FIGS. 8 to 10 show another specific embodiment of the system of electrodes 2 for the invention. It consists of a left electrode 2 and a right electrode 2 which interlock. The electrodes 2 are provided with stirring-up vanes 4 to create turbines for changing the laminar flow of water to the turbulent flow of water. FIG. 10 furthermore shows permanent magnets 14 which can streamline the process of physical water treatment. The permanent magnets 14 used in the embodiment of the invention are, for example, made of neodymium.

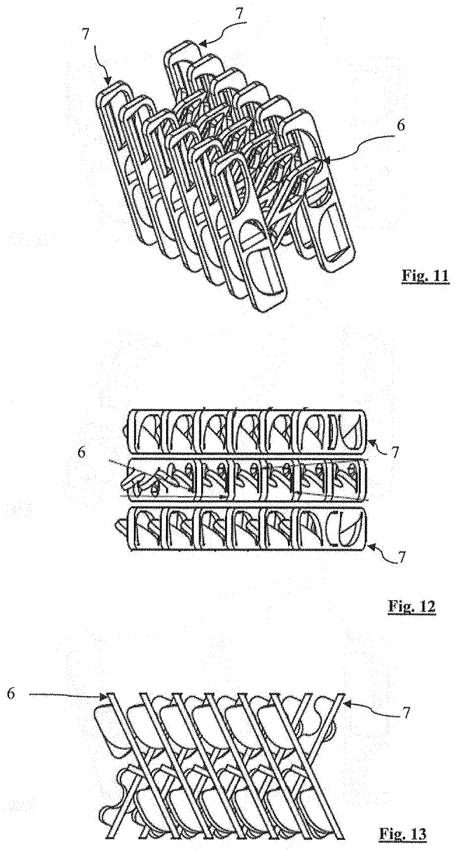

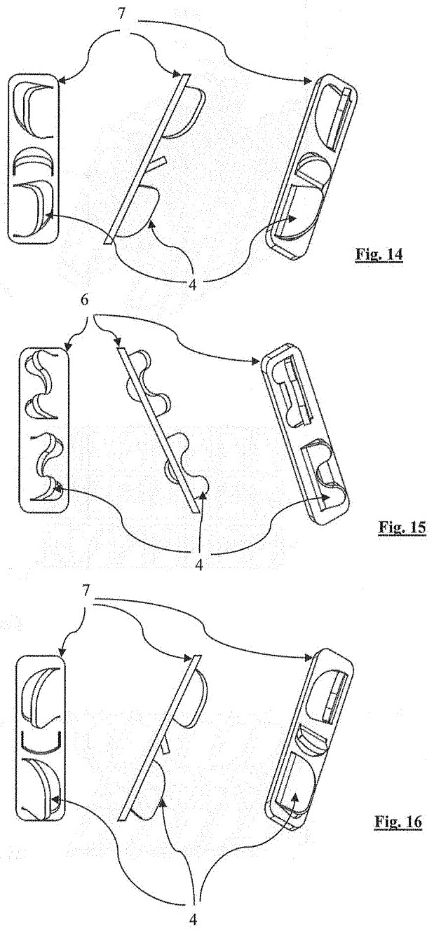

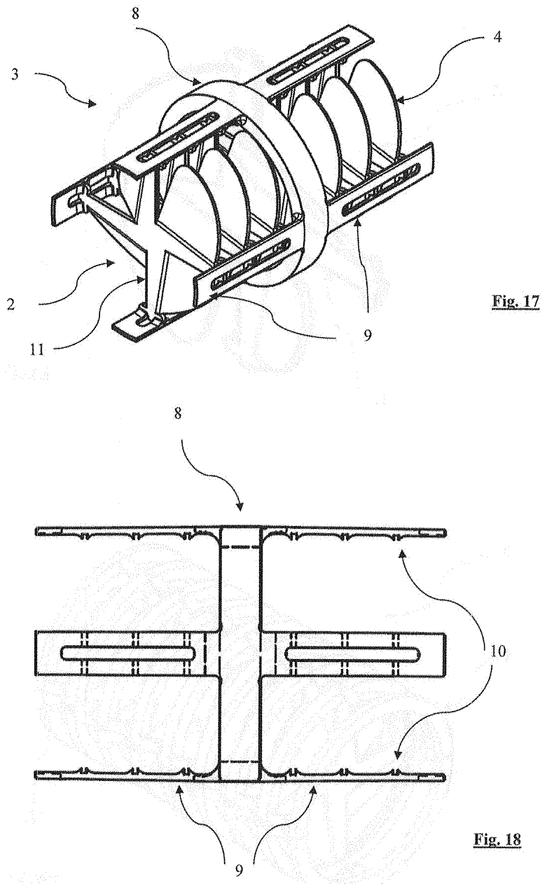

FIGS. 11 to 13 show another specific embodiment of the system of electrodes 2 for housing design. In the system of electrodes 2, end bevelled electrodes 7 and a central bevelled electrode 6 are used. The central bevelled electrodes 6 are bevelled in the opposite direction from the end electrodes 7. The detailed illustrations of electrodes 6 and 7 in FIGS. 14 to 16 show that these electrodes 6 and 7 also have stirring-up vanes 4.

The person skilled in the art will be able to design a wide range of design solutions of electrodes 2 for the systems of electrodes 2 inserted into capsules. The mentioned embodiments of the systems of electrodes 2 do not limit the scope of the invention, the essence of which lies mainly in the use of integral bodies 3 while maintaining the flexibility of the water inlet 1.

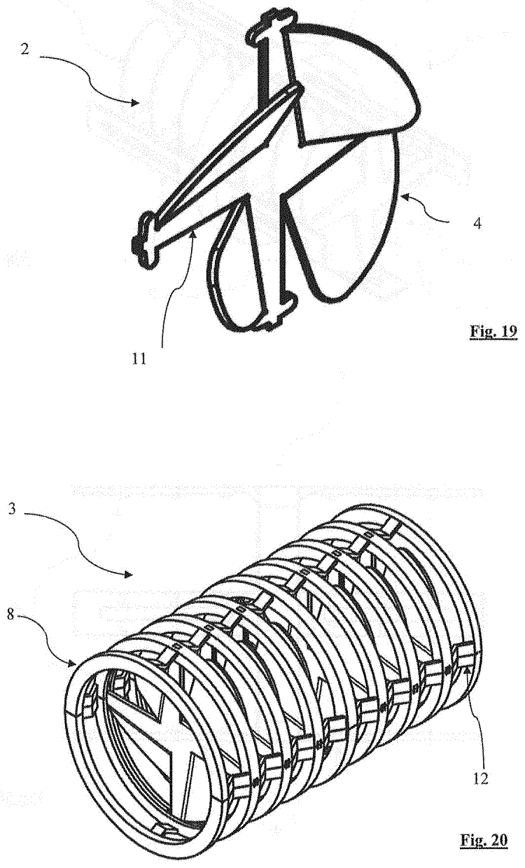

In another example of the invention embodiments according to FIG. 17, the integral body 3 is formed by a ring 8 from the front and rear sides of which four flexible terminals 9 of the electrodes 2 protrude. The terminals 9 are provided with grooves 10 for inserting the electrodes 2, which can be seen in detail in FIG. 18. The flexible terminals 9 copy the bending of the flexible water inlet 1.

The electrode 2 is shown in detail in FIG. 19. The electrode 2 has the shape of a combination of a support cross 11, whose ends of the arms fit into the grooves 10, and also of the stirring-up vanes 4, which resemble a propeller.

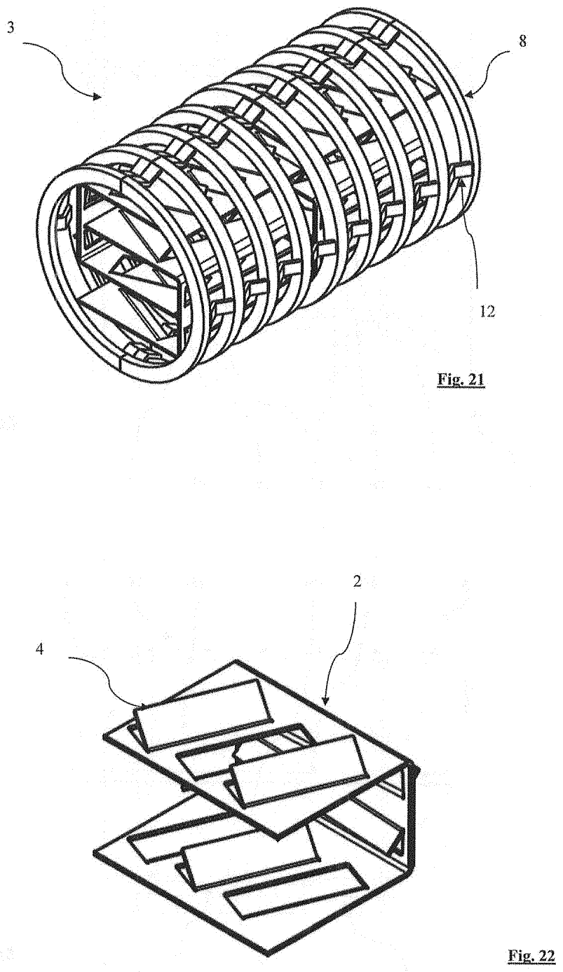

FIG. 20 shows another possible embodiment of the invention, in which the integral body 3 is formed by an assembly of at least three rings 8, with the electrodes 2 being fixed outside the end rings 8. The end rings 8 serve as protective bumpers. Flexible spacers 12 are between the rings 8 and prevent the rings 8 from detaching from the assembly or from being completely pressed together.

The electrodes 2 are circular, such as those shown in FIG. 19, or the electrodes 2 may be linear with a “U” profile. The electrodes 2 with a “U” profile are shown in FIGS. 21 and 22.

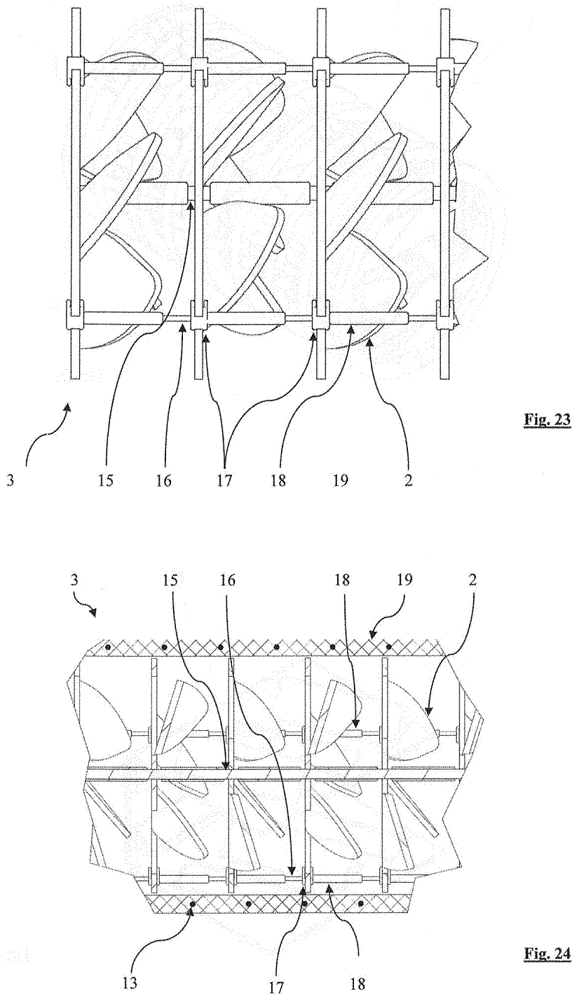

FIG. 23 shows the integral body 3 formed by fan-shaped electrodes 2. The electrodes 2 are slid on one inner rod 15 and on four peripheral rods 16. The rods 15 and 16 are flexible and can be made of plastic or metal, provided that the electrical connection between the electrodes 2 is prevented. The ends of the rods 15 and 16 are provided with locking means 17, which are made of plastic and prevent the electrodes 2 from slipping out of the rods 15 and 16. Other locking means 17 are only on the peripheral rods 16 at the points of intersection at the perimeter of the electrode 2. For electrical insulation, the electrodes 2 are provided with cut-outs and the locking means 17, which are plastic, are inserted into the cut-outs. Spacer rollers 18 are loosely slid on the rods 15 and 16 between the adjacent electrodes 2. The rollers 18 are made of rigid plastic.

FIG. 24 shows the integral body 3 which is inserted into an electrically non-conductive sleeve 19. The sleeve 19 isolates the electrodes 2 from the inner wall of the flexible water inlet 1. In addition, a metal screen forming an electromagnetic shielding 13 is built into the sleeve 19.

### INDUSTRIAL APPLICABILITY

The physical water treatment device according to the invention finds its application in particular in flexible water inlet pipes/hoses of domestic water appliances prone to limescale deposition, but also in other applications where it is necessary to physically treat water in a flexible water inlet.

### LIST OF REFERENCE NUMERALS

1 flexible water inlet
2 electrode for water galvanization
3 integral body
4 stirring-up vane
5 base opening
6 central bevelled electrode
7 end bevelled electrode
8 ring
9 flexible electrode terminal
10 groove of flexible electrode terminal
11 electrode cross
12 flexible spacer
13 electromagnetic field shielding
14 permanent magnet
15 inner rod
16 peripheral rod
17 locking means
18 spacer roller
19 sleeve

1. Physical water treatment device, in particular in a flexible water inlet (1), comprising at least one pair of electrodes (2) for water galvanization and at least one means for inserting and fixing the electrodes (2) characterized in that the means for inserting and fixing the electrodes (2) together with the electrodes (2) form an integral body (3) having the shape adapted for insertion into the flexible water inlet (1) and for complete blocking of the cavity of flexible water inlet (1), while the integral body (3) is hollow for the flow of water through it and the electrodes (2) of the integral body (3) form a flow-through turbulent galvanization system of electrodes.

2. The device according to claim 1, characterized in that the integral body (3) is adapted for fixed or loose insertion into a flexible water inlet (1).

3. The device according to claim 1, characterized in that it is formed by at least two integral bodies (3) arranged in a flexible water inlet (1) in a row one behind the other, or with arbitrary spacing.

4. The device according to claim 1, characterized in that the electrodes (2) of the integral body (3) are provided with openings for the flow of water through the electrodes (2), while at least some of the openings are provided with stirring-up vanes (4).

5. The device according to claim 1, characterized in that the integral body (3) is a capsule whose outer bases are straight, pyramidally raised, roundly convex, or a combination of the list of variants, with the end bases being provided with openings (5) for the flow of water through the capsule.

6. The device according to claim 5, characterized in that the electrodes (2) in the capsule are made of corrugated sheet metal and are sandwiched on top of one another.

7. The device according to claim 5, characterized in that the electrodes (2) in the capsule form at least one pair in which they interlock.

8. The device according to claim 5, characterized in that the electrodes (2) in the capsule form at least one row of three electrodes for blocking the flow of water, in which they are arranged bevelled and parallel next to each other, while the central bevelled electrode (6) is inclined from the end bevelled electrodes (7) in the opposite direction and forms a pair with each of the end bevelled electrodes (7) for water galvanization.

9. The device according to claim 1, characterized in that the means for inserting and fixing the electrodes (2) is formed by a ring (8) for creating a contact surface with the inner side of the flexible water inlet (1), and at the same time the flexible terminals (9) of the electrodes (2) protrude from the front and the rear of the ring (8).

10. The device according to claim 9, characterized in that the flexible terminals (9) of the electrodes (2) protrude symmetrically from the ring (8) and are provided with grooves (10) for the insertion of electrodes (2).

11. The device according to claim 9, characterized in that the electrodes (2) have the shape composed of a cross (11) for inserting its arms into the grooves (10) of the flexible terminals (9) and further of the stirring-up vanes (4) having a shape substantially similar to the shape of propeller blades.

12. The Device according to claim 1, characterized in that the means for inserting and fixing the electrodes (2) is formed by an assembly of at least three concentric rings (8) to form an interface with the inside of the flexible water inlet (1), in which the adjacent rings (8) are connected to each other by at least one flexible spacer (12), with at least some of the central rings (8) being provided with at least one groove for inserting the electrodes (2).

13. The device according to claim 12, characterized in that the electrodes (2) have the shape composed of a cross (11) for inserting its arms into the ring (8) and further of the stirring-up vanes (4) having a shape substantially similar to the shape of propeller blades.

14. The device according to claim 12, characterized in that the electrodes (2) are made of sheet metal “U” profile.

15. The device according to claim 14, characterized in that the two electrodes (2) of the “U” profile form at least one pair in which they interlock.

16. The device according to claim 1, characterized in that the means for inserting and fixing the electrodes (2) is formed by at least one inner rod (15) running through the electrodes (2), and at least two peripheral rods (16) running through the electrodes (2) at their perimeter, with the ends of the rods (15, 16) being provided with locking means (17), and further the peripheral rods (16) are provided with locking means (17) at the intersections through the electrode (2), with the spacer rollers (18) being loosely mounted on the rods (15, 16) between the two adjacent electrodes (2).

17. The device according to claim 16, characterized in that the integral body (3) is inserted into an electrically non-conductive sleeve (19).

18. The device according to claim 1, characterized in that the device is provided with a shielding (13) of electromagnetic fields in each of the integral bodies (3), or a common shielding arranged on the flexible water inlet (1) for at least two integral bodies (3) arranged in a row, or the device is provided with a shielding for arrangement between the inner wall of the flexible water inlet 1) and the integral body (3).

19. The device according to claim 1, characterized in that at least one flow-through turbulent galvanization system of electrodes is provided with at least one permanent magnet (14).
